(19) United States
(12) Patent Application Publication
(10) Pub. No.: US 2008/0302476 A1
(43) Pub. Date: Dec. 11, 2008

(54) METHOD TO BOND PLASTIC END CAPS TO POROUS FILTRATION BODIES

(75) Inventors: Govind Bommi, Bayshore Park (SG); Krishna Murthy Bommi, Bangalore (IN)

Correspondence Address: Levenfeld Pearlstein, LLC;Intellectual Property Department, 2 North LaSalle, Suite 1300, Chicago, IL, 60602, US

(73) Assignee: FILTREX HOLDINGS PTE LTD., Parklane Mall (SG)

(21) Appl. No.: 11/760,465

(22) Filed: Jun. 8, 2007

(51) Int. Cl. B29C 65/14

(52) U.S. Cl. 156/272.4

(57) ABSTRACT

A bonding method for a filtration unit for bonding a polymeric end cap to a porous filter element body includes providing a polymeric end cap of a filtration unit, providing a porous filter element body and positioning a hot melt adhesive element and a metal element between the porous filter element body and the end cap. A pressure is applied between the porous filter element body and the end cap and an electromagnetic field is induced at the metal element. The hot melt adhesive is melted and flows between the end cap and the porous filter element body and a bond is formed between the porous filter element body and the end cap.

### BACKGROUND OF THE INVENTION:

The present invention relates to a method of bonding plastic end caps to porous filter tubular bodies. More specifically, the present invention relates to a method of bonding plastic end caps to porous filter tubular bodies used in water filtration applications that uses an induction heating method of applying heat using eddy current heating in a current carrying metallic member.

Fluid filtration technologies are a well known industry. Depending on the contaminates in the fluid, various filtration methods can be used. In the batch treatment water filtration industry for home use and portable treatment units, fluid is passed through several filter bodies to remove specific contaminates. For suspended impurities, the fluid is passed through a porous sediment filter body composed of ceramic materials, polymeric materials consisting of polyethylene, polypropylene, polyvinyl chloride, and derivatives thereof, non woven fabrics and yarns. The filter bodies predominantly are tubular in shape. The fluid passes from the outside to inside of the filter thus trapping the sediments in the filter matrix. The filter bodies are attached to plastic end caps to facilitate attachment of the filtration filter body to the filtration unit. For organic impurities removal, compressed activated carbon black, molded in solid block form, is used.

Bonding similar materials such as plastic to plastic uses well known methods such as simple adhesive bonding and ultrasonic, frictional, and vibrational welding. In manufacturing porous fluid filter bodies, the challenge is in bonding the plastic cap to the porous filter body. In bonding these materials, conventional adhesive bonding is the typical method chosen. The most commonly used bonding media is a hot melt material of ethylene vinyl acetate (EVA) composition which, when heated, softens and can be applied between the inside surface of the end cap and the plastic porous filter body end surface to form the bond. The EVA bonding material is melted by a hand held adhesive gun. The melted adhesive material is then dispersed between the end cap and the porous filter body end surface. In high volume cartridge production, the EVA bonding material is melted in a separate melting chamber and the melted adhesive is then dispersed between the end cap and the plastic cartridge surface.

The above two conventional methods of melting the bonding media and applying the melted media are labor intensive. Determining the appropriate amount of hot melt adhesive to apply is a challenge since this is worker-skill-based. If the hot melt is not completely melted or if an adequate amount is not applied, the bond is weak, causing the end caps to come off the porous filter body.

To avoid a weak bond, more than needed adhesive is often applied on the joint. After the bonding material is applied, pressure is required and is applied by an external source.

The cure time and curing pressure applied depends on the amount of adhesive applied and temperature of the applied adhesive. The bond can be weak if temperature and applied pressure are not adequate during the curing of the bonding material.

Secure attachment of the end cap to the filter body is a time consuming operation and frequently, in spite of automation, is a bottle neck in the filter making operation.

Accordingly there is a need for a method to bond a polymer or plastic end cap to a porous filter body. Desirably, such a method can be carried out without impact to any downstream processes or devices. More desirably, such a method uses known materials and known processes. Most desirably, such a method can be carried out quickly and provides a strong and reliable bond between the end cap and the porous filter body.

### BRIEF SUMMARY OF THE INVENTION

A method for bonding plastic end caps to a porous filter tubular body uses induction heating. An electric current is induced in a current carrying member. The current carrying members can be formed from a metal foil disk, a metal mesh disk or a metal particle impregnated hot melt disk. The current carrying member, which contains metal, becomes heated by electromagnetic induction to melt the hot melt adhesive.

Adhesive contact apertures and adhesive contact surfaces provide bonding areas. The plastic end caps s are bonded to the porous filter unit body by the melted hot melt adhesive which is melted in place of application.

The present method provides an improved production rate over prior art methods. The joint between the end cap and the filter body is held under pressure, by a separate, external source of pressure, to allow the hot melt to solidify to bond the end cap to the filter body.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is an assembled view of a portion of an exemplary filter system fabricated using a method to bond plastic end caps to porous filtration bodies in accordance with the principles of the present invention.

FIG. 2 is an exploded view of the portion of the exemplary filter system of FIG. 1, and illustrating an adhesive disk and a metal foil disk with adhesive contact apertures;

FIG. 3 is a plan view of the metal foil disk with the adhesive contact apertures;

FIG. 4 is a plan view of a metal mesh disk;

FIG. 5 is a cross-sectional view of the metal mesh disk molded inside plastic cap;

FIG. 6 is a plan view of hot melt adhesive disk with impregnated metal particles; and

FIG. 7 is a cross-sectional view of a portion of the filter system with an induction heat source positioned on the assembly.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent and Trademark Office, and does not imply, nor should be inferred to limit the subject matter disclosed herein.

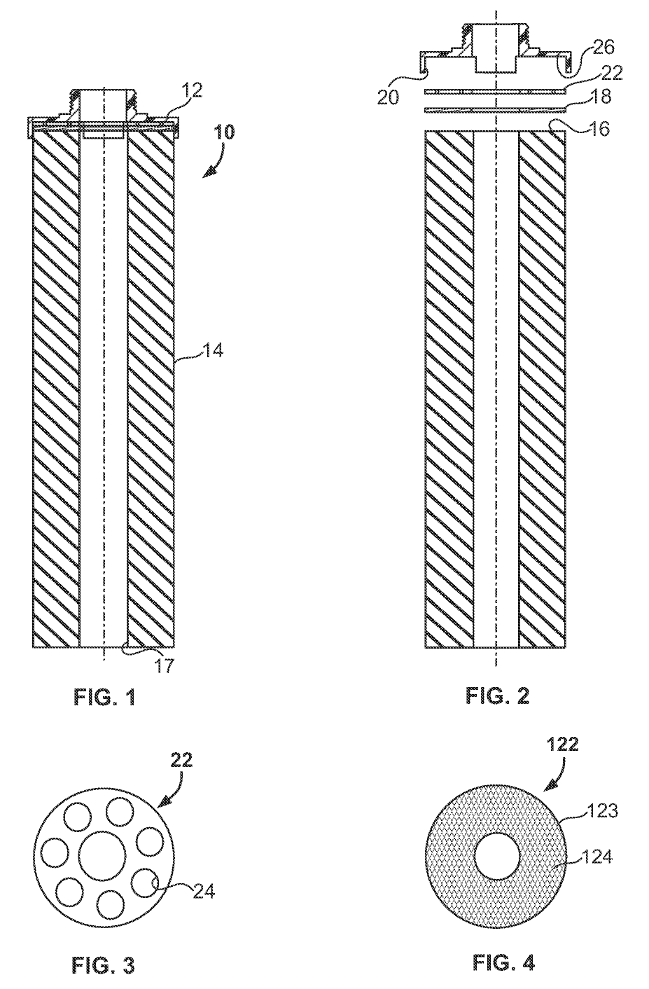

Referring now to the figures and in particular to FIG. 1, there is shown a portion of an exemplary filter system 10 fabricated using a method to bond plastic end caps 12 to porous filtration bodies 14 in accordance with the principles of the present invention. The portion of the system 10 is referred to as a portion in that it includes a porous filter body 14 that has a top surface 16, and a plastic end cap 12 attached to the filter body 14. The end cap 12 is then affixed to, for example a filter unit (not shown) to dispense filtered fluid, such as water.

In a typical filter, the filter body 14 has a tubular form and is fabricated from compressed activated carbon to remove chemical contaminants such as chlorine, volatile organic chemicals including herbicides, pesticides and disease causing cysts. The activated carbon black filter bodies are manufactured to a uniform density with an internal flow chamber 17 for effluent passage.

A molded hot melt disk 18 matches the inner periphery 20 of the plastic cap end 12 and is placed on the top surface 16 of the porous filter body 14. A metal foil element 22 with perforations or holes 24 that define adhesive contact apertures is placed on top of the disk 18. The plastic end cap 12 is placed on top of the metal foil 22 to permit the melted hot melt adhesive to contact the inner surface 26 of the plastic end cap 12 through the adhesive contact apertures 24.

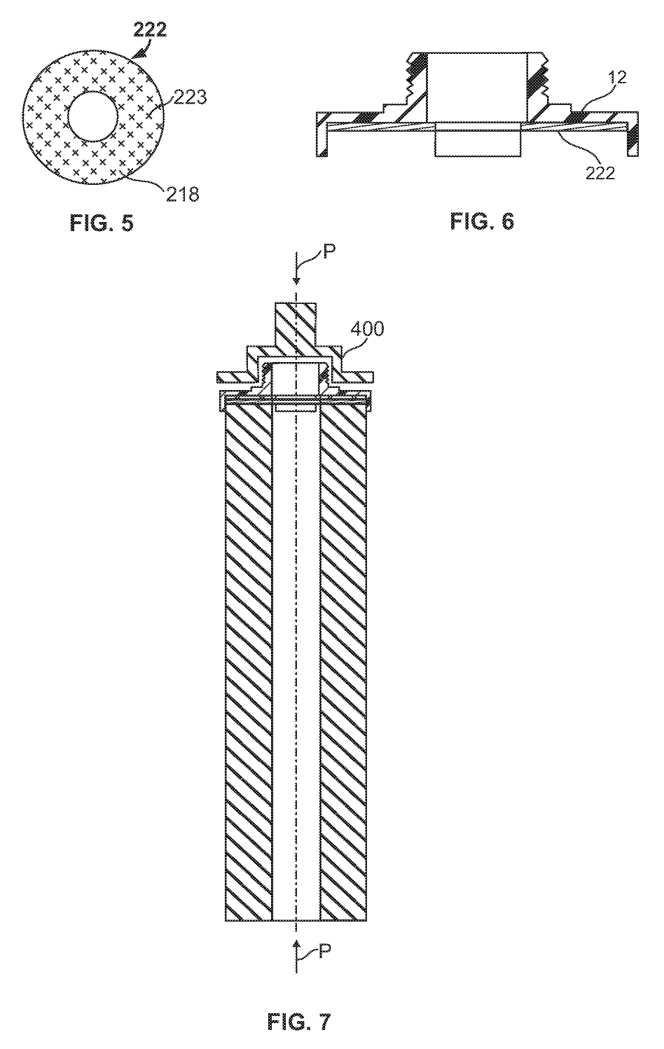

FIG. 3 is a plan view of the metal foil 22 with perforations 24 that define the adhesive contact apertures. FIG. 4 is an alternate disk 122 formed as a metal mesh in which open mesh spaces 124 of the mesh net 123 can be used to generate melt heat. Alternately still, FIG. 5 shows a matrix 222 of metal filings 223 or particles dispersed within a molded hot melt disk 218. FIG. 6 is a cross-sectional view showing a disk (for example, disk 222) positioned within the cap 12. It will also be appreciated that both the metal foil and the mesh can be integrated into a matrix formed as a disk with the hot melt adhesive.

Referring again to FIG. 3, the perforations or holes 24 define adhesive contact apertures. The size and number (e.g., the area) of the adhesive contact apertures 24 is sufficient to provide contact with a bonding surface of the inner surface 26 of the plastic end cap 12 to effect a secure bond to the cap 12. The apertures 24 can consist of up to at least 40% of the interior bonding surface of the end cap for a secure adhesive bond. The metal mesh 122 provides an extremely large number of adhesive contact surfaces 12 4to increase the effective contact aperture bonding surface. The metal filings 223 dispersed within the matrix 222 of the hot melt adhesive 218 also serve to increase the effective contact bonding surface of the end cap 12.

In this invention the hot melt bonding material disk 18, 218 is molded (as a solid unit to be inserted into the cap 12) to fit the size of the porous filter body 14. In a present method, the thickness of the molded hot melt disk 18, 218 can be about 0.5 mm to about 5 mm, and preferably about 1.5 mm thick. The perforated heat generating metal member 22, 122 is typically of any conducting material, preferably an aluminum foil made of commercial aluminum that is 99% pure aluminum. The thickness of this aluminum foil is 50 to 100 microns, which is sufficient to melt the hot melt disk by induction heating. The aluminum foil disk is of the same circular dimension as the hot melt disk.

Referring to FIG. 7, the cap assembly (the cap 12, the metal/conducting element 22, 122 and the holt melt disk 18, 218, or the hot melt disk with metal particles 222) is positioned adjacent (or under) an induction heating unit energy device 400. The induction device generates an electromagnetic field which in turn creates heat in the metal element 22, 122, 223 by inducing eddy currents in the metal element. The generated heat melts the hot melt adhesive disk (in contact with the metal) in place of application. Pressure is applied on the cap assembly by a separate source of external pressure P.

The hot melt adhesive 18, 218, when melted, is dispersed evenly on the top 16 of the porous filter body 14. The hot melt adhesive 18, 218 establishes a bond (not unlike a weld) between the end cap 12 and the filter body 14 as it flows through the contact apertures 24 in the aluminum foil disk 22 or through the open mesh apertures 124 to bond the inside surface 26 of the plastic end cap 12 and the top surface 16 of the porous filter body 14 or by direct contact (without an intermediate metal element) with the metal/hot melt matrix disk 222.

There are a number of advantages of bonding the cap to the porous filter body by the present induction heating process. First is the fast cycle time that can be achieved by the induction heating process. The hot melt adhesive is melted in its place of application. The heating (welding) cycle requires only about 10 to 20 seconds during which electromagnetic energy is applied to the aluminum foil to heat and raise the temperature of the foil to above the melting point of the hot melt adhesive (to cause the hot melt adhesive to flow evenly over the adjoining surfaces). A slightly longer time may be required for the metal mesh and metal particle embodiments to heat the hot melt adhesive to an appropriate melt temperature.

Another important advantage of this invention is that the bond strength is consistent over the joined surfaces. In current practice, the hot melt is dispersed at the connecting juncture. The dispersion in current practice is frequently not consistent. As a result, the bond strength is not consistent. Conversely, using the present method, the bond strength is strong and consistent because the same high melt temperature generated by the aluminum foil disk or mesh or aluminum particles uniformly melts the hot melt adhesive allowing it to flow between the surfaces of the cap and the filter body. In current industrial practice of applying the hot melt adhesive there is no assurance that the melt is of a uniform temperature or is consistently applied throughout the juncture of the surfaces. Still another advantage of the present method is that the hot melt is uniform in thickness and temperature thus forming a uniform bonding surface.

As seen in FIG. 2, the metal current conducting disk 22 or metal mesh 122 is positioned inside of the cap 12 and the hot melt adhesive disk 18 is positioned on the metal disk 22, 122, so as to fit within the periphery of the bonding surface 26 of the end cap 12. The assembly is then positioned on the filter body 14. Alternately, the positions of the metal disk 22, 122 and hot melt adhesive 18 can be switched. It will of course be appreciated that when the adhesive/metal particle matrix disk 222 is used, it is positioned between the end cap 12 and the filter body 14.

Those skilled in the art will appreciate that the electromagnetic field from the induction coil induces eddy currents in the metal to heat the metal which in turn melts the adhesive disk. External pressure P is applied to press the end cap 12 and porous filter body 14 together to form the unit. The melted hot melt adhesive 18 contacts the porous filter body 14 through the open spaced aluminum foil and bonds the plastic end cap through the adhesive contact apertures to the porous filter body unit.

As noted above, the present method is applicable in the fabrication of water filtration units that employ water filtration filter bodies to remove harmful contaminants and sediment in drinking water including chemical and particulate contaminants and biological contaminants such as protozoan cysts. The present method provides an improved production rate and quality for attaching porous water treatment filtration bodies to plastic end caps. It has also been found that the method provides a highly secured cap/body joint. That is, the joint does not loosen nor lose integrity upon use, as other boding methods may.

The cap and body are joined by a hot melt adhesive by a strong bond in which the adhesive is consistently applied in a uniform amount (thickness) at a uniform temperature to provide a strong heat-sealed bond between the porous filter body and the plastic end-cap. Thus there is also a savings vis-a-vis overuse of manually applied hot melt adhesive.

Uniformity of amount applied is provided by use of a uniformly sized adhesive disk placed within the periphery of the filtration unit plastic end cap. Uniformity in temperature is obtained by used of a controlled induction heating system. The current conducting material is heated by induced eddy currents to a temperature sufficient to cause the hot melt adhesive disk to uniformly melt at a uniform temperature to a uniform consistency to provide a uniform adhesive strength bond between the plastic end cap of the filtration unit and the filtration filter body.

As set forth above, the carbon block of the filter body 14 is of a form of carbon consisting of carbon black. Carbon black is a form of amorphous activated carbon used as a clarifying or filtering agent. The specific carbon blocks of activated carbon of the instant invention are manufactured by a patented compression molding process with a unique two component binder system and are available from Filtrex International Pte, Ltd. of Singapore. The uniform conditions of the invented method ensure the hot melt adhesive is well-melted and applied uniformly in a production line of the invented method. The end cap is typically a polymer, such as polyethylene, polypropylene, polyvinyl chloride and derivatives thereof. The adhesive, of course is selected to be compatible with the cap material.

The present invention is not limited to a conducting material of aluminum to apply an electromagnetic field to heat the conducting material. Other conducting metals can be used instead of aluminum.

Selection of an appropriate hot melt adhesive 18, 218 that is suitable for the present method should include consideration of the conditions of flowability of the hot melt composition at the temperature generated by application of the electromagnetic current to a conducting material such as an aluminum metal. The hot melt adhesive can be selected from a number of commercially available hot melt adhesives with required flowability and required adhesion to plastic surfaces and carbon materials (porous block) at the desired induction heating temperatures.

Examples of typical hot melt EVA adhesives are taught in U.S. Pat. No. 4,684,554 and are commercially available from a wide variety of sources. Several typical ethylene/vinyl acetate adhesive compositions are taught having a vinyl acetate content of from about 8 to 66 percent by weight and a melt index equal to or greater than about 1.5 grams per 10 minutes. Other adhesive comparisons are ethylene/methacrylate copolymers having approximately 80 percent by weight ethylene and approximately 20 percent by weight methacrylate and having a melt index equal to or less than about 600 grams per 10 minutes, and ethylene/vinyl acetate/methacrylic acid and terpolmers having a vinyl acetate content between about 4 and 30 percent by weight and melt index being equal to or less than about 600 grams per 10 minutes. Selection of a suitable hot melt adhesive can be based accordingly and/or on other considerations and desired characteristics.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the invention.

What is claimed is:

1. A bonding method for a filtration unit for bonding a polymeric end cap to a porous filter element body, comprising the steps of:
providing a polymeric end cap of a filtration unit;
providing a porous filter element body;
positioning a hot melt adhesive element and a metal element between the porous filter element body and the end cap;
applying a pressure between the porous filter element body and the end cap;
inducing an electromagnetic field at the metal element;
melting the hot melt adhesive and flowing the melted adhesive between the end cap and the porous filter element body; and
forming a bond between the porous filter element body and the end cap.

2. The method in accordance with claim 1 wherein the hot melt disk adhesive element and the metal element are disposed within an annulus region in the end cap.

3. The method in accordance with claim 1 wherein the hot melt adhesive element is disposed adjacent the porous filter element body and the metal element is disposed adjacent the end cap.

4. The method in accordance with claim 1 wherein the metal element is formed having multiple openings therein.

5. The method in accordance with claim 4 wherein the metal element is a metal foil and wherein the openings are contact openings.

6. The method in accordance with claim 5 wherein the contact openings have an area that is up to about 40 percent of a bonding surface area of the end cap.

7. The method in accordance with claim 4 wherein the metal element is a metal mesh.

8. The method in accordance with claim 1 wherein the hot melt adhesive is an ethylene vinyl acetate (EVA) composition.

9. The method in accordance with claim 1 wherein the metal element is formed as metal particles dispersed in a matrix that includes the hot melt adhesive.

10. The method in accordance with claim 1 wherein the porous filter body is a ceramic material, a non-woven fabric polymer selected from the group consisting of polyethylene, polypropylene, polyvinyl chloride and derivatives thereof, or compressed carbon black to form a carbon block, and wherein the end cap is formed from polyethylene, polypropylene, polyvinyl chloride or derivatives thereof.

11. A method for a bonding a filtration unit for bonding a polymeric end cap having a periphery to a porous filter body, comprising the steps of:
providing a current carrying member formed of metal which fits within the periphery of the end cap and is inserted therein;
inserting a hot melt adhesive in the form of a disk into the periphery of the end cap;
providing an annular shaped porous filter body of annular end dimensions of a size which fits within the periphery of the end cap;
positioning the porous filter body into engaging contact with the hot melt adhesive disk;
applying an external pressure between the end cap and the porous filter body;
introducing an electromagnetic field at the current carrying member metal;
heating to melting the hot melt adhesive in place of application to adhesively bond the end cap and the porous filter body; and

12. The method in accordance with claim 11 wherein the current carrying member is a metal foil with adhesive contact apertures therein.

13. The method in accordance with claim 12 wherein the current carrying member has adhesive contact apertures having an area of a current carrying foil of metal of as much as 40 percent of the bonding surface area of the internal bonding surface of the end cap.

14. The method in accordance with claim 12 wherein the hot melt adhesive is an ethylene vinyl acetate (EVA) composition.

15. The method in accordance with claim 12 the current carrying member is a metal mesh and is of a size to fit within the periphery of the end cap.

16. The method in accordance with claim 12 wherein composition of the porous filter body formed from a ceramic material, a non-woven fabric polymer or compressed carbon black to form a carbon block, and wherein the end cap is a polymer.

17. The method in accordance with claim 16 wherein the non-woven fabric is one or more of polyethylene, polypropylene, polyvinyl chloride and derivatives thereof.

18. The method in accordance with claim 16 wherein the end cap is one or more of polyethylene, polypropylene, polyvinyl chloride and derivatives thereof.
